(19) United States
(12) Patent Application Publication
(10) Pub. No.: US 2009/0257854 A1
(43) Pub. Date: Oct. 15, 2009

(54) Self-leveling roll-on/roll-off container for transporting on a tiltable platform

(75) Inventors: Steven Wright, Suffolk, VA (US); James Kenneth Jolley, Suffolk, VA (US)

Correspondence Address: KRATZ, QUINTOS & HANSON, LLP, 1420 K Street, N.W., Suite 400, WASHINGTON, DC, 20005, US

(73) Assignee: BOXX SYSTEMS, Portsmouth, VA (US)

(21) Appl. No.: 12/081,329

(22) Filed: Apr. 15, 2008

(51) Int. Cl. B60P 1/64

(52) U.S. Cl. 414/499

(57) ABSTRACT

A tiltable platform and container system employs a container on a tilted platform which when released will move rearwardly under the influence of gravity to an off-loading position. The container is loaded by a winch and cable attachable to the container to roll the container onto the trailer. The container is provided with individually vertically adjustable rear ground engaging means whose vertical adjustments are controlled by at least one pitch-sensitive switch which enables the container to remain substantially level during loading and unloading from a tilted platform.

### FIELD

The present invention relates to a self-leveling container for loading on and off a tiltable platform.

### BACKGROUND

The present invention relates to freight containers and more particularly to an improved system for transporting freight containers. Trailers of this general type are sometimes referred to as trailers for roll-on, roll-off containers.

In the residential and commercial moving industry there are several traditional approaches to moving personal and business possessions and equipment. One approach is to engage a commercial mover who will pack and transport the items in a truck and trailer. On the other hand, many individuals and businesses prefer the “do it yourself” approach and to this end will rent or lease a truck for this purpose. Rental trucks of this type are generally provided with some type of ramp which may be attached to or extends from the truck bed to facilitate loading and unloading of the truck body.

Another approach that has found acceptance is the use of large containers of the type similar to sea cargo containers. Such containers provide an economical method for moving items and can also be used for temporarily storing the goods. Typically the storage container is transported to a site such as a home or business and is unloaded and left for a period of time during which period the container is loaded. Once loaded, the container is transported to a new location for unloading or storage.

One particular problem of adapting these large containers to moving and storage use is the problem of handling these containers. Loading and unloading such containers which may measure 10′(H)×40′(L) and have a tare weight of 9,000 pounds, without disturbing their contents, is formidable. Typically, in the transportation industry, loading and unloading of the containers is accomplished by fork lift or other similar industrial lifting equipment which maintain the containers in a substantially level orientation during handling.

Other approaches for loading large containers which have been used in the container trucking industry involve the use of detachable container systems of the type which are known as roll-on, roll-off arrangements. Various patents covering such type of arrangements can be found in the prior art.

For example, the early patent to Jackson et al, U.S. Pat. No. 1,442,769 shows a truck or vehicle with a tilting platform. The vehicle has a winch which may be utilized to pull a vehicle or other load up the runway of the platform.

Various other patents show tiltable trailers of the general type having cable systems for pulling the container onto the tilt frame and for off-loading the container. Typical of these are U.S. Pat. Nos. 3,964,626; 4,051,968; 4,704,062 and 4,702,622.

U.S. Pat. No. 4,645,405 shows a handling mechanism for roll-off containers including elongated lift frame pivotally connected to a truck chassis with hydraulic tilt rams. This patent contains a general discussion of systems of the type above which are generally classified as roll-on, roll-off trailers.

U.S. Pat. No. 3,934,740 discloses an improved over-the-road transport vehicle and method of unloading a cargo container. The transport vehicle has a chassis having a wheeled tandem support and a flatbed that is selectively positionable relative to the tandem and which may be tilted on the tandem to permit the container support to be moved longitudinally off the flatbed to an adjacent surface. The container is rectangular in shape and has extensible and retractable support dollies to convert the container from an immobile frame-based storage container to a mobile wheel-hauling container for convenient placement onto and off of the chassis flatbed.

U.S. Pat. No. 4,645,406 shows a container loader and transport assembly having a horizontal bed with a loader assembly. The loader is movably mounted to the bed and includes a carriage and lifting mechanism mounted to the carriage. The loader is constructed to lift the container and lower it while maintaining the container in substantially a horizontal position.

U.S. Pat. No. 5,324,160 teaches a tiltable trailer for loading, unloading and transporting containers, wherein a container is loaded by a winch and cable and unloaded by gravity. The container is provided with removable or selectively positionable wheels or rollers which may be extended “a slight distance” or retracted as set out in FIGS. 20 to 23.

U.S. Pat. No. 5,088,876 discloses a roll-off hoist for variable positioning of containers from a tiltable bed which both tilts and extends relative to the chassis on which it rests.

U.S. Pat. Nos. 5,593,272 and 5,743,701 disclose a roll on/roll off receptacle handling system using a receptacle mounted on portable jacks.

While the above systems provide some advantages, they generally have certain drawbacks. One drawback is that many must be powered by specially constructed single purpose trucks. A further disadvantage of prior art devices is that they often require specially designed and built containers. Also, the tilting mechanisms are often complicated, expensive to build and difficult to operate. Furthermore, the storage container being loaded on or off a tiltable platform is subject to substantial pitching back which can cause shifting of container contents which may damage them.

Therefore, there exists a need for an effective, economical roll-on, roll-off container that can be loaded and unloaded from an inclined or tilted platform while maintaining a substantially level orientation that avoids damaging the container contents. It would be particularly advantageous to provide such a container by modifying a conventional container suited for use as personal and commercial moving and storage units.

### SUMMARY

In one aspect, the present invention relates to a storage container comprising: a) a storage area defined by a front wall, a rear wall, a left wall and a right wall and a floor, b) a fixture for attaching a cable, secured proximal to the outside of the front wall, c) at least two ground engaging means mounted proximal to the rear wall, each ground engaging means being individually mounted on a vertically adjustable jack, d) at least one level-sensing device mounted on the storage container which detects the pitch of the storage container from front to rear and provides an electrical signal to raise or lower the jacks as needed to maintain the floor at a substantially level pitch.

In another aspect, the present invention relates to a freight loading and transport system comprising:

(1) a storage container comprising: a) a storage area defined by a front wall, a rear wall, a left wall and a right wall and a substantially flat floor, b) a fixture for attaching a cable, secured proximal to the outside of the front wall, c) at least two ground engaging means mounted proximal to the rear wall, each ground engaging means being individually mounted on a vertically adjustable jack, and d) at least one level-sensing device mounted on the storage container which detects the pitch of the storage container from front to rear and provides an electrical signal to raise or lower the jacks as needed to maintain the floor at a substantially level pitch;

(2) a substantially fixed transport bed having a front and rear and supported on a wheel assembly;

(3) a tiltable platform tiltable between a generally horizontal position and a rearwardly inclined position relative to said transport bed for loading and unloading; and

(4) a winch associated with the transport bed or tiltable platform, comprising a cable securable to the fixture of the storage container.

### BRIEF DESCRIPTION OF THE DRAWINGS

FIG. 1 is a side elevation view of the system of the freight loading and transport system of the present invention showing a first stage of unloading of the storage container in which the tiltable platform is slightly tilted back and the rear ground engaging means of the storage container in a retracted position.

FIG. 2 is a side elevation view of the freight loading and transport system of the present invention showing a second stage of unloading of the storage container in which the tiltable platform is slightly tilted back with the rear of the storage container extending beyond the platform, and the rear ground engaging means of the storage container in a fully or substantially extended position.

FIG. 3 is a side elevation view of the freight loading and transport system of the present invention showing a third stage of unloading of the storage container in which the tiltable platform is further tilted back with the rear of the storage container extending beyond the platform, the rear ground engaging means in a partially extended position, wherein only the front portion of the storage container is supported by the tiltable bed.

FIG. 4 is a side elevation view of the freight loading and transport system of the present invention showing a fourth stage of unloading of the storage container in which the storage container has been unloaded from the tiltable bed and the rear ground engaging means are in a retracted position.

FIG. 5 is a rear perspective view of a storage container of the present invention providing a detailed view of the rear ground engaging means (and jacks) in an extended position.

FIG. 6 depicts a simple level-sensing device for electrically controlling extension and retraction of the rear ground engaging means of the storage container.

### DETAILED DESCRIPTION

Briefly, the present invention relates to a freight loading system comprising a tiltable platform and container. The tiltable platform can be integrated with a fixed transport bed having a front and rear and supported on a wheel assembly. The transport bed itself can be supported by a wheel assembly, for example, that of a conventional truck chassis, or a trailer which can be hitched to a tow vehicle, e.g., a truck tractor.

The wheel assembly on which the fixed transport bed is supported typically includes a carriage having pneumatic tires. The tiltable platform is pivotally connected to the fixed transport bed at an intermediate location and is pivotable by a suitable means, e.g., a hydraulic cylinder. In the normal traveling or towing position, the tilt frame is level or slightly rearwardly inclined. When the container is released and rolls rearwardly on the tiltable platform during unloading, the tilt frame will, due to the weight of the container, tilt rearwardly to an off-loading position.

To facilitate and control loading and unloading, the tiltable platform or fixed transport bed is provided with a cable winch at the front end. The roll-on, roll-off container is provided with a fixture for attaching a cable, secured proximal to the outside of the front wall of the container, preferably near the lower, center portion of the front wall. The winch may be driven by any suitable means, say, an electric motor or a hydraulic pump.

The storage container has ground engaging means at the rear of the storage container. Preferably, the storage container will also have at least one front ground engaging means mounted proximal to the front wall. Typically the ground engaging means are located at or proximal to the corners of the container. Suitable ground engaging means are selected from the group consisting of wheels, rollers, casters, and skids. Rotatable ground engaging means, e.g., wheels, rollers, and casters, are especially preferred, and can be mounted so as to be fixed in a substantially longitudinal direction, guiding the storage container in a substantially straight line, or in an alternative embodiment on swivels. In one embodiment, the rotatable ground engaging means can be locked into a non-rotating position, if needed to assist loading and unloading of the storage container from the tiltable platform. For example, locking the wheels of a ground engaging means can be useful during unloading from a tiltable platform when rearward movement of the storage container is temporarily undesirable, say, during extension of the jacks of the rear ground engaging means to level the storage container.

The ground engaging means can be readily attachable and detachable to the storage container, typically by nuts and bolts, a key hole-shaped slot and stud, straps, clamps, e.g., U-clamps or quick-release lever actuated clamps, pegs and holes, or other suitable mechanisms known to those of skill in the art. Each ground engaging means can be individually mounted on a vertically adjustable jack. Such a jack can be selected from the group consisting of mechanical ratchet and pawl jacks, bottle jacks etc., which can be electrically actuated, pneumatically actuated or hydraulically actuated jacks. The ground engaging means can be attached to the storage container by securing the jack portion to the storage container. Each ground engaging means mounted to a jack can be secured to the storage container so that when the jack is fully retracted, the ground engaging means will not engage the ground, i.e., at least the rear bottom surface of the storage container will contact the ground. When extended, the ground engaging means can lift the rear portion of the storage container as far as necessary to maintain a substantially level pitch of the storage container during loading and unloading of the storage container from a tiltable platform. Typically, the ground engaging means can lift the storage container at least about 24 inches, preferably beyond about 36 inches or even beyond about 48 inches when engaging the ground surface. In one embodiment, the storage container of the invention can comprise additional ground engaging means at each corner, e.g., rotatable ground engaging means such as wheels or rollers, which are either non-extending or slightly extendable. These can lift the storage container slightly from the ground, typically no more than about 0.1 to about 6 inches from the ground. Preferably, these can be permanently mounted. Such additional ground engaging means are present in addition to the extendable rear ground engaging means.

Associated with the storage container of the present invention is at least one level-sensing device which detects the pitch of the storage container from front to rear and provides an electrical signal to raise or lower the jacks as needed to maintain the floor of the storage container at a substantially level pitch. By substantially level pitch is meant a pitch that is sufficiently close to level to prevent shifting of the contents of the storage container. Substantially level pitch for present purposes can vary from the normal by not more than about ±_°, preferably not more than about ±_°, say, not more than about ±_°. The level-sensing device can comprise a suitable level-sensor such as a liquid metal switch, e.g., a mercury switch. The level-sensing device can comprise a three-way or three-position switch, which is wired to extend a rear jack or jacks when the storage container is pitched backwards, retract a rear jack or jacks when the storage container is pitched forward, and switched off when the sensor is substantially level. Thus, the at least one level-sensing device can comprise a pitch-sensitive three-way switch. The level sensing device can be mounted on any suitable surface of the storage container including inside or outside of the storage container, including on one or more rear ground engaging means. The switch is mounted in such a way that the switch will be in the off position when the surface container is substantially level. A single level sensing device can be used to control a plurality of the rear jacks which can be operated in tandem. Thus, the present invention can comprise a storage container which has only one level-sensing device.

In one embodiment of the storage container of the present invention, a single level-sensing device is associated with only a single rear jack such that each rear jack will individually conform to the ground surface on which the rear portion of the storage container is supported during loading and unloading. This is especially suited to situations where the ground surface is laterally uneven, i.e., uneven from one side of the storage container to the other. Individual control of each rear jack thus permits additional flexibility of operation with uneven ground surfaces. In one embodiment of the invention, each level-sensing device can be mounted to a rear vertically adjustable jack itself. Thus, the at least one level-sensing device can be integral to or mounted on each jack. An example of a suitable level-sensing system for present purposes is the AutoLevel™ available from Equalizer Systems of Elkhart, Ind., USA.

In one embodiment, the vertically adjustable jack can be controlled by an activation and/or override switch which can be remotely operated. Such a switch can be controlled by an operator to activeate and/or override the level-sensing device, as necessary.

A typical storage container for the present invention can be of a construction similar to seaworthy or seagoing cargo containers.

In operation, the storage container can be transported on the tiltable platform to a site, e.g., on a truck or a trailer towed by a tractor or other device. At the site, the tiltable platform is backwardly tilted to an extent sufficient to induce rearward movement of the storage container as the cable winch is released. The container rolls rearwardly to cause the rear of the storage container to extend beyond the tiltable platform. At this stage, the level sensing device is activated to permit extension of the rear jacks to support the rear portion of the storage container at a substantially level pitch. The tiltable platform can then be eased forward relative to the storage container which tends to lower the front end of the storage container while it is still on the tiltable platform. As the front end of the storage container is thus lowered, the level-sensing device retracts the rear jacks to lower the rear portion of the storage container to a level approximate to that of the front portion. During this operation, the rotatable ground engaging means can be fixed, locked, or otherwise secured as necessary, to prevent uncontrolled slippage of the storage container down the tiltable platform, particularly if the cable winch has been previously released. Also, the truck or platform can be moved forward during unloading as needed, to assist in unloading, particularly after the rear ground engaging means have established contact with the ground. By the time the front end of the storage container reaches the rear portion of the tiltable platform, both ends of the storage container are fairly close to the ground and the rear ground engaging means are essentially retracted.

Once the storage container is substantially free of the tiltable platform and substantially level on the ground, the winch cable can be unhooked and the rear ground engaging means including the rear jacks can be readily detached from the rear portion of the lowered storage container. The truck and/or trailer may be used for other purposes.

To load a storage container in accordance with the present invention, the reverse operation is performed, using the cable winch rather than gravity to move the storage container along and up the tiltable platform. When the container has been loaded, the truck and/or trailer are returned to the site and the rear jacks can be reinstalled if previously removed. Such reinstallation can be carried out without the need to hoist or jack up the storage container, provided the rear ground engaging means are in the retracted position, and hence do not engage the ground during installation. The container is then connected to the winch cable attached to the winch on the fixed bed or the tiltable platform and the winch is actuated. As the container is rolled forwardly and upwardly to the loaded position along the rearwardly tilted platform, the level-sensing device or devices will actuate the rear jacks as needed to maintain a substantially level pitch. Also, the truck or platform itself can be moved backwards during loading as needed, to assist in loading, particularly while the rear ground engaging means are in contact with the ground. The rotatable ground engaging means can be rotationally locked as necessary to assist during loading and unloading.

Turning now to the drawings, in FIGS. I to 5 the freight loading and transport system of the present invention is generally designated by the numeral 10 which includes a container 12 and a tiltable platform 125 which is towable by a truck 16.

The container 12 as shown is generally rectangular and preferably being of steel construction having right side wall 20 and a left side wall, top 24, floor 26, front wall 28 and rear wall 30. The rear wall 30 is typically provided with one or more doors which may be hinged to open, or of the shutter type mounted on a track (similar to an overhead garage door) which may be raised to provide access to the interior compartment of the container. Containers of this type come in various standard sizes as, for example, 10′×10′ in cross-section and 20′ to 40′ in length, and are sometimes designated sea containers. On the front wall is secured an eye fixture 40 to which is attachable a J-hook 118 secured to a cable 120 reeved about the cable drum of a winch 114 reversibly driven by a motor which may be electric, hydraulic or pneumatic. The winch is used to load the container onto the tiltable platform and to control the off-loading. Opposite lower edges of the front wall 28 can be provided with mounting means to removably receive a front roller assembly (not shown). On each side of the rear wall is mounted a ground engaging means 31 comprising a roller assembly (right side shown) that includes a wheel or roller 32 secured to lower extendible member of a vertically adjustable jack 34 actuated by an electric motor 36 controlled by a level-sensing device 38 attached to the jack. The jack can be an electrically actuated jack of the type available from Rieco Titan Products of Frankfort, Ill., USA, which may be remotely controlled.

The main stationary chassis or substantially fixed transport bed 80 supports a tiltable platform 125. The transport bed is supported on a wheel carriage assembly 90 having pneumatic tires 91. Tandem dual wheel arrangements are typically provided on either side of the trailer. Normal safety equipment such as a braking system and brake lights are also provided but are not shown in the interest of clarity.

The forward end of the transport bed 80 defines an elevated platform 95 formed from suitable structural members and elevated above the chassis. The tiltable platform 125 is pivotally connected to the transport bed and is tiltable by a hydraulic cylinder 92 (shown in FIG. 3). The tilting movement of the tiltable platform is controlled as hydraulic fluid bleeds between the internal chambers within the cylinder.

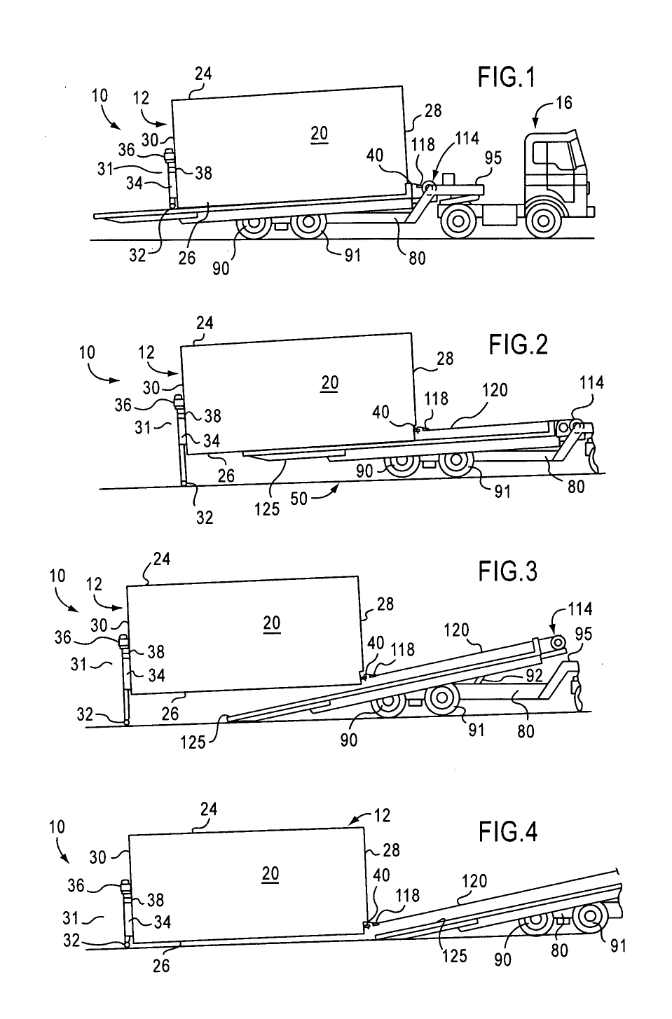

The present invention will be better understood from the following description of operation. Referring to FIGS. 1 to 4, the freight loading and transport system is shown in various operational modes. In FIG. 1, container 12 is loaded onto the tiltable platform 125 which can be slightly rearwardly inclined as shown (or horizontal during transport, if desired) but well above the road surface for transportation. When the truck is driven to the site where the container is to be used, as for example, in residential use, the container may be left in the driveway or on the street. At this point, the operator will disengage the winch drive 114 so that the cable drum is rotated to pay-out cable 120. Since the tiltable platform is slightly rearwardly inclined, gravity will cause the container 12 to roll rearwardly (on auxiliary storage container roller assemblies, if present). The container will continue to move rearwardly. During this phase of unloading, the rear ground engaging means 31 of the storage container is in a retracted position if other ground engaging means are available to support the container, otherwise the rear ground engaging means is extended only slightly to permit rolling of the storage container on the tiltable bed without significantly raising the rear portion of the storage container.

When the rear end of the storage container 12 has passed beyond the end of the tiltable platform 125, the rear ground engaging means 31 is activated to extend the jack so the wheel 32 engages the ground so as to keep the storage container at a substantially even pitch, before the center of gravity of the storage container extends beyond rear of the tiltable platform, i.e., the “tipping point.” FIG. 2 shows a side elevation view of the system of the freight loading and transport system 10 of the present invention showing a second stage of unloading of the storage container in which the tiltable platform 125 is slightly tilted back with the rear of the storage container extending beyond the platform, and the rear ground engaging means of the storage container in an extended position. As the storage container 12 passes rearwardly and downwardly along the tiltable bed 125, the rear ground engaging means 31 can be operated to slowly retract the jack so as to maintain a substantially even pitch as the storage container 12 descends. FIG. 3, a side elevation view of the system of the freight loading and transport system 10 of the present invention shows a third stage of unloading of the storage container 12 in which the tiltable platform 125 is further tilted back to coax down the storage container. The rear ground engaging means 31 is further retracted and only the front portion of the storage container 12 is supported by the tiltable bed 125. FIG. 4, a side elevation view of the system of the present invention shows a fourth stage of unloading of the storage container 12 in which the storage container has been removed from the tiltable bed 125 and the rear ground engaging means are in a retracted position. At this point, the J-hook 118 may be disengaged from the bracket 40 at the front end 26 of the container and the container left in position on site for loading by the user. The cable drum may be reversely operated to take-up the cable and the cable secured in place. The tiltable platform 125 is returned to the substantially horizontal or slightly tilted position free of its load and if desired, the storage container and/or tiltable platform are locked in this position.

The operator can then detach the retracted rear ground engaging means 31 (without having to jack up the storage container) for use elsewhere, if desired. The unloaded storage container is ready for loading by the user.

When the container has been loaded with goods, the user contacts the moving operator and the tractor or truck 16 is returned to the residence location and the rear ground engaging means 31 are reattached to the storage container 12, if previously removed. The tiltable platform 125 is placed in alignment with the storage container 12. The cable 120 is paid out and the J-hook 118 is connected to the bracket 40 at the front end of the container as shown in FIG. 4. The operator then operates the winch 114 to cause the cable 120 to be wound about the cable drum drawing the container 12 forward onto the tiltable platform 125. As the container ascends, the rear ground engaging means 31 are extended to provide a substantially level pitch as shown in FIG. 3. When the storage container's center of gravity has moved past the rear end of the tiltable platform (beyond the “tipping point”) the tiltable platform 125 can be tilted forward to allow a substantial portion of the storage container to be supported by the tiltable platform which will permit substantially complete retraction of the rear ground engaging means 31 which no longer has to support the storage container 12. The storage container is then drawn up the tiltable platform until it reaches a transport position as shown in FIG. 1, at which point the storage container can be secured as necessary. The truck may now be driven to move the container to its desired destination and at that point, the container may be unloaded in the manner described above.

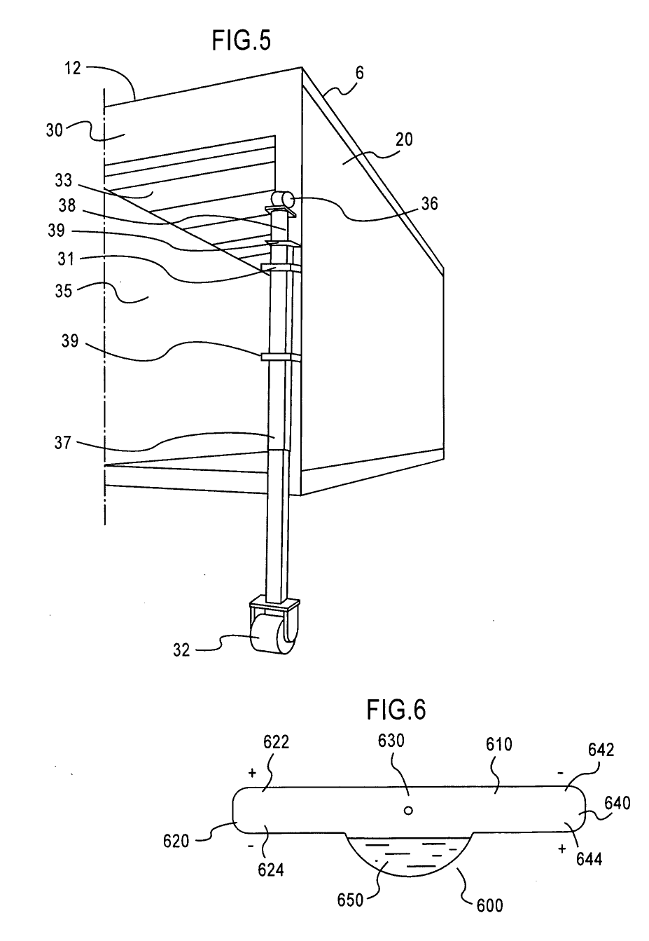

FIG. 5 is a rear perspective view of a substantially level storage container 12 of the present invention on an inclined surface, showing additional details. FIG. 5 provides a detailed view of the rear side 30, the right side 20 and rear ground engaging means 31 showing a lower extended portion of the extended jack 37 on which is mounted a wheel or roller 32. Atop the rear ground engaging means is an electric motor 36 connected to a power source which extends or retracts jacking mechanism as directed by a level-sensing device 38 mounted at a suitable point on the storage container, e.g., on the rear ground engaging means itself. The rear ground engaging means is secured to the rear of the storage container at two locations by readily detachable bolt and clamp combinations 39. An overhead door 33 with handle 35 located at the rear section 33 is shown in the partially open position.

FIG. 6 shows a simple level-sensing device 600 for use with the present invention comprising an oblong glass vessel 610 for mounting on any appropriate part of the storage container (including rear ground engaging means). The glass vessel comprises a forward section 620 (directions are relative to the storage container) with opposed through-glass electrodes 622 and 624 connected to the electric motor of the rear ground engaging means, a central reservoir section 630 with no electrodes, and a back section 640 with opposed through-glass electrodes 642 and 644 connected to the electric motor of the rear ground engaging means and arranged to carry current of a reversed polarity from the front section electrodes. An electrically conducting liquid, e.g., mercury 650 is present within the vessel in an amount sufficient to provide the electrically conducting liquid to establish an electrical circuit between the electrodes of one section or another depending on the pitch of the storage container and associated level-sensing device. When level, no electrical circuit is completed and the electric motor associated with the rear ground engaging means is off. When pitched forward, the completed circuit formed by the flow of mercury in the front section will retract the rear ground engaging means of the storage container. Similarly, when pitched back, the rear ground engaging means will extend, resulting in maintaining a substantially level pitch of the storage container associated with the device.

As indicated above, the present system is particularly adaptable for loading, unloading and transporting containers, particularly larger containers such as sea cargo or moving containers, while maintaining them at a substantially level pitch. Generally these containers will vary in size but generally approximately 8′ wide and 10′ to 40′ length. Containers of this type are suitable for moving both household items and personal belongings as well as commercial freight. From the foregoing, it will be appreciated that the transport vehicle system of the present invention facilitates convenient transfer of large heavy cargo containers between a truck chassis and a work area without the requirement and expense of special lifting equipment. Moreover, such loading and unloading may be accomplished by the driver of the truck so as to reduce labor costs attendant to the operation. Only simple equipment is required for maintaining a storage container at a level pitch during unloading, loading and transport using a tiltable platform.

It will be obvious to those skilled in the art to make various changes, alterations and modifications to the container transport and loading system of the present invention. To the extent such changes, alterations and modifications do not depart from the spirit and scope of the appended claims, they are intended to be encompassed therein.

What is claimed is:

1. A storage container comprising:
a) a storage area defined by a front wall, a rear wall, a left wall and a right wall and a floor,
b) a fixture for attaching a cable, secured proximal to the outside of the front wall,
c) at least two ground engaging means mounted proximal to the rear wall, each ground engaging means being individually mounted on a vertically adjustable jack,
d) at least one level-sensing device mounted on the storage container which detects the pitch of the storage container from front to rear and provides an electrical signal to raise or lower the jacks as needed to maintain the floor at a substantially level pitch.

2. The storage container of claim 1 further comprising
e) at least one front ground engaging means mounted proximal to the front wall.

3. The storage container of claim 1 wherein the ground engaging means are selected from the group consisting of wheels, rollers, casters, and skids.

4. The storage container of claim 3 wherein the ground engaging means are selected from the group consisting of wheels and rollers, mounted in a substantially longitudinal direction.

5. The storage container of claim 1 wherein the ground engaging means are readily attachable and detachable.

6. The storage container of claim 1 wherein the at least one level-sensing device is integral to or mounted on each jack.

7. The storage container of claim 1 wherein the at least one level-sensing device is a single level-sensing device.

8. The storage container of claim 1 wherein the at least one level-sensing device comprises a pitch-sensitive three-way switch.

9. The storage container of claim 8 wherein the at least one level-sensing device comprises a mercury switch.

10. The storage container of claim 1 wherein the jack is selected from the group consisting of electrically actuated jacks, pneumatically actuated jacks, and hydraulically actuated jacks.

11. A freight loading and transport system comprising:
(1) a storage container comprising: a) a storage area defined by a front wall, a rear wall, a left wall and a right wall and a substantially flat floor, b) a fixture for attaching a cable, secured proximal to the outside of the front wall, c) at least two ground engaging means mounted proximal to the rear wall, each ground engaging means being individually mounted on a vertically adjustable jack, and d) at least one level-sensing device mounted on the storage container which detects the pitch of the storage container from front to rear and provides an electrical signal to raise or lower the jacks as needed to maintain the floor at a substantially level pitch;
(2) a substantially fixed transport bed having a front and rear and supported on a wheel assembly;
(3) a tiltable platform tiltable between a generally horizontal position and a rearwardly inclined position relative to said transport bed for loading and unloading; and
(4) a winch associated with the transport bed or tiltable platform, comprising a cable securable to the fixture of the storage container.

12. The system of claim 11 wherein the tiltable platform is also extendible in a substantially horizontal direction relative to the transport bed

13. The system of claim 11 further comprising
e) at least one front ground engaging means mounted proximal to the front wall.

14. The system of claim 11 wherein the ground engaging means are rotatable ground engaging means selected from the group consisting of wheels, rollers, casters, and skids.

15. The system of claim 11 wherein the ground engaging means are readily attachable and detachable.

16. The system of claim 11 wherein the at least one level-sensing device is integral to or mounted on each jack.

17. The system of claim 11 wherein the at least one level-sensing device comprises a pitch-sensitive three-way switch.

18. The system of claim 11 wherein the at least one level-sensing device comprises a mercury switch.

19. The system of claim 11 wherein the jack is selected from the group consisting of electrically actuated jacks, pneumatically actuated jacks and hydraulically actuated jacks.
